(19) United States
(12) Patent Application Publication
(10) Pub. No.: US 2026/0342454 A1
(43) Pub. Date: Oct. 29, 2026

(54) TECHNIQUES FOR EFFECTIVE ISOTROPIC RADIATED POWER (EIRP) MASK COMPLIANCE ESTIMATION VIA BOOTSTRAP RESAMPLING

(71) Applicant: QUALCOMM Incorporated, San Diego, CA (US)

(72) Inventors: Vasanthan RAGHAVAN, West Windsor Township, NJ (US); Mustafa EMARA, Munich (DE)

(21) Appl. No.: 19/188,863

(22) Filed: Apr. 24, 2025

(51) Int. Cl. H04B 17/10; H04B 7/0426; H04B 17/15; H04B 17/20

(52) U.S. Cl. CPC H04B 17/102; H04B 7/043; H04B 17/191; H04B 17/25

(57) ABSTRACT

This disclosure provides methods, components, devices and systems for techniques for effective isotropic radiated power (EIRP) mask compliance estimation via bootstrap resampling. For example, a network entity may perform bootstrap resampling on a sample space of EIRP measurements to obtain bootstrap confidence interval to verify conformance of the network entity with one or more EIRP mask threshold values. The network entity may obtain configuration information for EIRP mask compliance estimation over a zenith angle for wireless transmissions of the network entity. The network entity may transmit a first quantity of signals for measurement of the EIRP, obtain the first quantity of EIRP measurements, and perform bootstrap resampling to obtain the bootstrap confidence interval associated with the first quantity of EIRP measurements. The bootstrap confidence interval may be provided to the compliance entity to verify conformance of the network entity with one or more EIRP mask threshold values.

### TECHNICAL FIELD

This disclosure relates generally to wireless communication, and more specifically to systems, devices, methods, and techniques associated with techniques for effective isotropic radiated power (EIRP) mask compliance estimation via bootstrap resampling.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a network entity is described. The method may include obtaining configuration information for effective isotropic radiated power (EIRP) mask compliance estimation over a zenith angle for wireless transmissions of the network entity, the configuration information indicating a first quantity of EIRP measurements to be taken over a first quantity of beamforming directions and a first quantity of azimuth angles, and the configuration information further indicating a first quantity of samples of the first quantity of EIRP measurements to be used for bootstrap resampling of the first quantity of EIRP measurements to obtain a bootstrap confidence interval associated with the first quantity of EIRP measurements, outputting a first quantity of signals for measurement of the EIRP, the first quantity of signals associated with to the first quantity of EIRP measurements, obtaining the first quantity of EIRP measurements of the first quantity of signals, determining, based on a set of multiple average EIRP measurements from a set of multiple different subsets of the first quantity of EIRP measurements, the bootstrap confidence interval associated with the first quantity of EIRP measurements, where each of the set of multiple different subsets of the first quantity of EIRP measurements include a quantity of samples corresponding to the first quantity of samples, and outputting the bootstrap confidence interval to verify conformance of the network entity with one or more EIRP mask threshold values.

A network entity for wireless communications is described. The network entity may include a processing system that includes processor circuitry and memory circuitry that stores code. The processing system may be configured to cause the network entity to obtain configuration information for EIRP mask compliance estimation over a zenith angle for wireless transmissions of the network entity, the configuration information indicating a first quantity of EIRP measurements to be taken over a first quantity of beamforming directions and a first quantity of azimuth angles, and the configuration information further indicating a first quantity of samples of the first quantity of EIRP measurements to be used for bootstrap resampling of the first quantity of EIRP measurements to obtain a bootstrap confidence interval associated with the first quantity of EIRP measurements, output a first quantity of signals for measurement of the EIRP, the first quantity of signals associated with to the first quantity of EIRP measurements, obtain the first quantity of EIRP measurements of the first quantity of signals, determine, based on a set of multiple average EIRP measurements from a set of multiple different subsets of the first quantity of EIRP measurements, the bootstrap confidence interval associated with the first quantity of EIRP measurements, where each of the set of multiple different subsets of the first quantity of EIRP measurements include a quantity of samples corresponding to the first quantity of samples, and output the bootstrap confidence interval to verify conformance of the network entity with one or more EIRP mask threshold values.

Another network entity for wireless communications is described. The network entity may include means for obtaining configuration information for EIRP mask compliance estimation over a zenith angle for wireless transmissions of the network entity, the configuration information indicating a first quantity of EIRP measurements to be taken over a first quantity of beamforming directions and a first quantity of azimuth angles, and the configuration information further indicating a first quantity of samples of the first quantity of EIRP measurements to be used for bootstrap resampling of the first quantity of EIRP measurements to obtain a bootstrap confidence interval associated with the first quantity of EIRP measurements, means for outputting a first quantity of signals for measurement of the EIRP, the first quantity of signals associated with to the first quantity of EIRP measurements, means for obtaining the first quantity of EIRP measurements of the first quantity of signals, means for determining, based on a set of multiple average EIRP measurements from a set of multiple different subsets of the first quantity of EIRP measurements, the bootstrap confidence interval associated with the first quantity of EIRP measurements, where each of the set of multiple different subsets of the first quantity of EIRP measurements include a quantity of samples corresponding to the first quantity of samples, and means for outputting the bootstrap confidence interval to verify conformance of the network entity with one or more EIRP mask threshold values.

A non-transitory computer-readable medium storing code for wireless communications is described. The code may include instructions executable by one or more processors to obtain configuration information for EIRP mask compliance estimation over a zenith angle for wireless transmissions of the network entity, the configuration information indicating a first quantity of EIRP measurements to be taken over a first quantity of beamforming directions and a first quantity of azimuth angles, and the configuration information further indicating a first quantity of samples of the first quantity of EIRP measurements to be used for bootstrap resampling of the first quantity of EIRP measurements to obtain a bootstrap confidence interval associated with the first quantity of EIRP measurements, output a first quantity of signals for measurement of the EIRP, the first quantity of signals associated with to the first quantity of EIRP measurements, obtain the first quantity of EIRP measurements of the first quantity of signals, determine, based on a set of multiple average EIRP measurements from a set of multiple different subsets of the first quantity of EIRP measurements, the bootstrap confidence interval associated with the first quantity of EIRP measurements, where each of the set of multiple different subsets of the first quantity of EIRP measurements include a quantity of samples corresponding to the first quantity of samples, and output the bootstrap confidence interval to verify conformance of the network entity with one or more EIRP mask threshold values.

In some examples of the method, network entities, and non-transitory computer-readable medium described herein, the configuration information further includes a first quantity of resampling averages that indicates how many different subsets of the first quantity of EIRP measurements are included in the set of multiple different subsets of the first quantity of EIRP measurements.

In some examples of the method, network entities, and non-transitory computer-readable medium described herein, the bootstrap confidence interval is determined prior to deployment of the network entity in a wireless communications network, or subsequent to deployment of the network entity in the wireless communications network. In some examples of the method, network entities, and non-transitory computer-readable medium described herein, the bootstrap confidence interval is determined in an on-demand manner subsequent to deployment of the network entity in the wireless communications network.

In some examples of the method, network entities, and non-transitory computer-readable medium described herein, the conformance of the network entity with one or more EIRP mask threshold values is communicated for multiple communication states of the network entity based on different beamforming behavior or traffic conditions of the network entity. In some examples of the method, network entities, and non-transitory computer-readable medium described herein, the first quantity of samples of the first quantity of EIRP measurements are defined in a regulatory specification for EIRP measurements. In some examples of the method, network entities, and non-transitory computer-readable medium described herein, multiple different values of the first quantity of samples are provided in the configuration information, and the network entity outputs bootstrap confidence intervals for each of the multiple different values of the first quantity of samples.

A method for wireless communications by a second network entity conforming to EIRP regulations is described. The method may include transmitting, to a first network entity, configuration information for EIRP mask compliance estimation over a zenith angle for wireless transmissions of the first network entity, the configuration information indicating a first quantity of EIRP measurements to take over a first quantity of beamforming directions and a first quantity of azimuth angles, and the configuration information further indicating a first quantity of samples of the first quantity of EIRP measurements to be used for bootstrap resampling of the first quantity of EIRP measurements to obtain a bootstrap confidence interval range of the first quantity of EIRP measurements, receiving, from the first network entity, the bootstrap confidence interval range for the first quantity of EIRP measurements of the first network entity, and verifying conformance of the first network entity with one or more EIRP threshold values.

A second network entity conforming to EIRP regulations for wireless communications is described. The second network entity conforming to EIRP regulations may include a processing system that includes processor circuitry and memory circuitry that stores code. The processing system may be configured to cause the second network entity conforming to EIRP regulations to transmit, to a first network entity, configuration information for EIRP mask compliance estimation over a zenith angle for wireless transmissions of the first network entity, the configuration information indicating a first quantity of EIRP measurements to take over a first quantity of beamforming directions and a first quantity of azimuth angles, and the configuration information further indicating a first quantity of samples of the first quantity of EIRP measurements to be used for bootstrap resampling of the first quantity of EIRP measurements to obtain a bootstrap confidence interval range of the first quantity of EIRP measurements, receive, from the first network entity, the bootstrap confidence interval range for the first quantity of EIRP measurements of the first network entity, and verify conformance of the first network entity with one or more EIRP threshold values.

Another second network entity conforming to EIRP regulations for wireless communications is described. The second network entity conforming to EIRP regulations may include means for transmitting, to a first network entity, configuration information for EIRP mask compliance estimation over a zenith angle for wireless transmissions of the first network entity, the configuration information indicating a first quantity of EIRP measurements to take over a first quantity of beamforming directions and a first quantity of azimuth angles, and the configuration information further indicating a first quantity of samples of the first quantity of EIRP measurements to be used for bootstrap resampling of the first quantity of EIRP measurements to obtain a bootstrap confidence interval range of the first quantity of EIRP measurements, means for receiving, from the first network entity, the bootstrap confidence interval range for the first quantity of EIRP measurements of the first network entity, and means for verifying conformance of the first network entity with one or more EIRP threshold values.

A non-transitory computer-readable medium storing code for wireless communications is described. The code may include instructions executable by one or more processors to transmit, to a first network entity, configuration information for EIRP mask compliance estimation over a zenith angle for wireless transmissions of the first network entity, the configuration information indicating a first quantity of EIRP measurements to take over a first quantity of beamforming directions and a first quantity of azimuth angles, and the configuration information further indicating a first quantity of samples of the first quantity of EIRP measurements to be used for bootstrap resampling of the first quantity of EIRP measurements to obtain a bootstrap confidence interval range of the first quantity of EIRP measurements, receive, from the first network entity, the bootstrap confidence interval range for the first quantity of EIRP measurements of the first network entity, and verify conformance of the first network entity with one or more EIRP threshold values.

In some examples of the method, second network entity conforming to effective isotropic radiated powers (EIRPs), and non-transitory computer-readable medium described herein, the configuration information further includes a first quantity of resampling averages that indicates how many different subsets of the first quantity of EIRP measurements are included in a set of multiple different subsets of the first quantity of EIRP measurements that are used to determine the bootstrap confidence interval range from the first quantity of EIRP measurements.

In some examples of the method, second network entity conforming to effective isotropic radiated powers (EIRPs), and non-transitory computer-readable medium described herein, the bootstrap confidence interval is obtained prior to deployment of the first network entity in a wireless communications network, or subsequent to deployment of the first network entity in the wireless communications network. In some examples of the method, second network entity conforming to effective isotropic radiated powers (EIRPs), and non-transitory computer-readable medium described herein, the bootstrap confidence interval is obtained in an on-demand manner subsequent to deployment of the first network entity in the wireless communications network. In some examples of the method, second network entity conforming to effective isotropic radiated powers (EIRPs), and non-transitory computer-readable medium described herein, the conformance of the first network entity with one or more EIRP mask threshold values is determined for multiple communication states of the first network entity based on different beamforming behavior or traffic conditions of the first network entity.

In some examples of the method, second network entity conforming to effective isotropic radiated powers (EIRPs), and non-transitory computer-readable medium described herein, the first quantity of samples of the first quantity of EIRP measurements is defined in a regulatory specification for EIRP measurements. In some examples of the method, second network entity conforming to effective isotropic radiated powers (EIRPs), and non-transitory computer-readable medium described herein, multiple different values of the first quantity of samples are provided in the configuration information, and the first network entity outputs bootstrap confidence interval ranges for each of the multiple different values of the first quantity of samples.

### BRIEF DESCRIPTION OF THE DRAWINGS

FIG. 1 shows an example of a wireless communication system.

FIG. 2 shows an example of a signaling configuration that supports techniques for EIRP mask compliance estimation via bootstrap resampling.

FIG. 3 shows an example of a resampling configuration that supports techniques for EIRP mask compliance estimation via bootstrap resampling.

FIG. 4 shows a block diagram of a processing system that supports techniques for EIRP mask compliance estimation via bootstrap resampling.

FIG. 5 shows a diagram of a system including a device that supports techniques for EIRP mask compliance estimation via bootstrap resampling.

FIGS. 6 and 7 show flowcharts illustrating methods that support techniques for EIRP mask compliance estimation via bootstrap resampling.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, transmitting network entities, such as gNBs, radio units, radio heads, and the like, may be subject to regulatory limits on an amount of energy that may be emitted in certain directions. For example, regulatory limits may limit an amount of energy that is emitted at elevations above an elevation of the transmitting entity, which may reduce potential interference that may be experienced by aircraft or satellites. Such limits may be defined as an equivalent isotropic radiated power (EIRP) mask that provide a maximum allowable radiated power of a transmitter at different angles away from a main beam of the transmitter. In cases of elevation transmissions, the EIRP mask may cap an amount of interference seen by satellites, aircraft, drones, or other aerial objects, which may be referred to generally as potential victim nodes. EIRP masks may be defined for certain frequencies. For example, for C-band transmissions (up to 3.98 GHz) EIRP masks may help prevent interference to radio altimeters operating in the 4.2-4.4 GHz range. As demand for wireless communications increases, frequency bands that may be subject to EIRP masks may be desirable for some deployments. In order to use frequency bands that are subject to EIRP mask definitions, a transmitting device, such as a network entity of a wireless communications network, may perform compliance tests to verify that one or more EIRP masks are complied with. In cases where numerous network entities are to be deployed across a relatively large geographic area, efficient techniques for performing compliance tests and reporting compliance of network entities are desirable. Further, in order to have a high degree of confidence that an EIRP mask definition is met, a relatively large number of samples may be needed, which may consume a relatively large amount of power and take a relatively long time. Thus, techniques to enhance the efficiency of sampling for EIRP mask conformance are also desirable.

Aspects of the subject matter described in this disclosure relate to EIRP mask compliance estimation via bootstrap resampling in a wireless communications system. For example, a network entity may perform bootstrap resampling on a sample space of EIRP measurements to obtain bootstrap confidence interval to verify conformance of the network entity with one or more EIRP mask threshold values. In some aspects, the network entity may obtain configuration information for EIRP mask compliance estimation over a zenith angle for wireless transmissions of the network entity. In some aspects, the configuration information may be obtained from a compliance entity (e.g., a second network entity) that verifies conformance to EIRP regulations. In some aspects, the configuration information may indicate that a first quantity of EIRP measurements to be taken over a first quantity of beamforming directions and a first quantity of azimuth angles, as well as a quantity of samples of the first quantity of EIRP measurements to be used for bootstrap resampling of the first quantity of EIRP measurements to obtain the bootstrap confidence interval associated with the first quantity of EIRP measurements. The network entity may transmit a first quantity of signals for measurement of the EIRP, obtain the first quantity of EIRP measurements, and perform bootstrap resampling to obtain the bootstrap confidence interval associated with the first quantity of EIRP measurements. The bootstrap confidence interval may be provided to the compliance entity to verify conformance of the network entity with one or more EIRP mask threshold values. In some aspects, the EIRP measurements and bootstrap confidence interval determination may be performed prior to deployment of the network entity in the wireless communications network. Additionally, or alternatively, the EIRP measurements and bootstrap confidence interval determination may be performed after the deployment of the network entity in the wireless communications network. Further, in some aspects, communication of conformance may be dynamic or time-dependent as the network entity changes beamforming behavior to traffic conditions.

Particular aspects of the subject matter described in this disclosure can be implemented to realize one or more of the following potential advantages. In some examples, by performing bootstrap resampling to obtain the bootstrap confidence interval associated with the first quantity of EIRP measurements, the described techniques can be used to verify EIRP conformance using a relatively small quantity of measurements and associated transmissions from the network entity, which may reduce an amount of time associated with conformance testing while maintaining a relatively high confidence in conformance to regulations. Further, by performing conformance testing after a network entity is deployed in a wireless communications network, verification of conformance may be performed based on beamforming changes or different traffic conditions that may occur subsequent to the deployment. Additionally, by providing configuration information for EIRP mask compliance estimation to a network entity, compliance may be verified based on particular regulations associated with a geographic area in which the network entity is deployed, or based on updated or additional regulations.

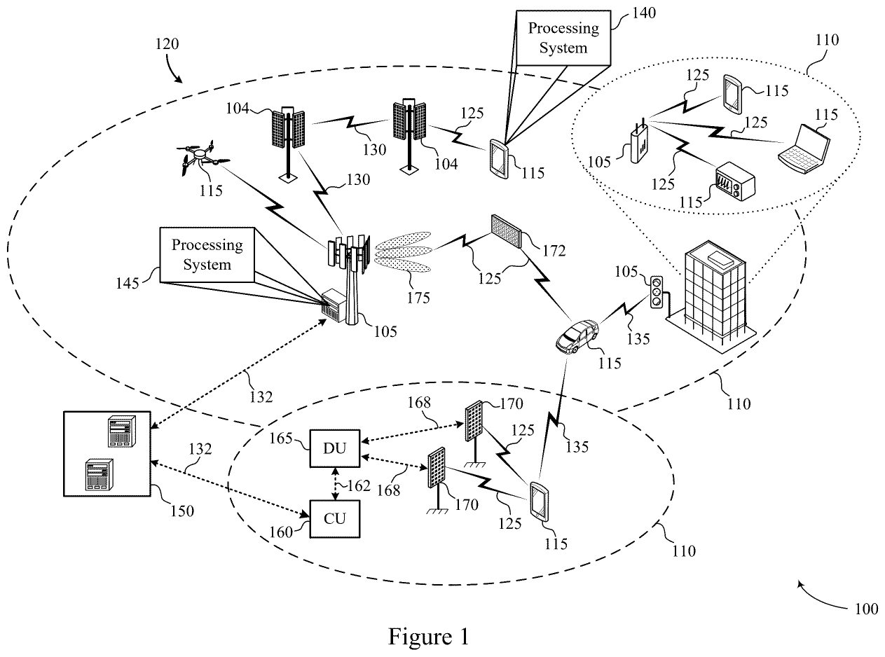

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. W ireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. A n RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for techniques for EIRP mask compliance estimation via bootstrap resampling. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support performance of bootstrap resampling obtain a bootstrap confidence interval associated with the first quantity of EIRP measurements, which may be used to verify EIRP conformance using a relatively small quantity of measurements and associated transmissions from a network entity, and may reduce an amount of time associated with conformance testing while maintaining a relatively high confidence of conformance.

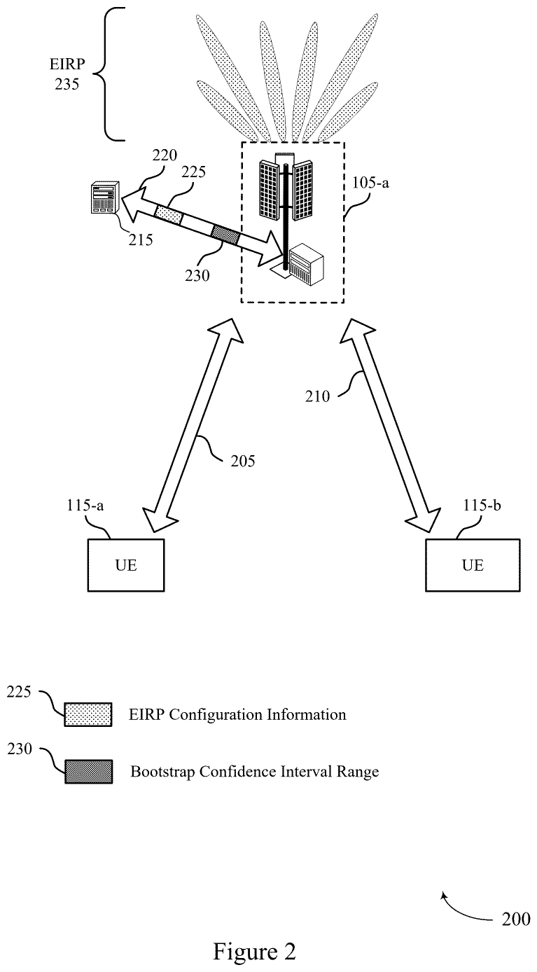

FIG. 2 shows an example of a signaling configuration 200 that supports techniques for EIRP mask compliance estimation via bootstrap resampling. In some examples, signaling configuration 200 may implement aspects of wireless communications system 100. In the example of FIG. 2, signaling configuration 200 may include a first network entity 105-a, a second network entity 215, a first UE 115-a, and a second UE 115-b. The first network entity 105-a, first UE 115-a, and second UE 115-b may be examples of the corresponding devices described with respect to FIG. 1. The second network entity 215 may be an example of a core network entity or a compliance entity that verifies conformance to EIRP regulations.

In accordance with various aspects, the first network entity 105-a may communicate with the first UE 115-a via a first connection 205 (e.g., a connection via a Uu interface), and may communicate with the second UE 115-b via a second connection 210 (e.g., a connection via the Uu interface). The first network entity 105-a may also communicate with the second network entity 215 via link 220, which may be a wireless link or a wired link. In some aspects, the second network entity 215 may transmit EIRP configuration information 225 to the first network entity 105-a.

As discussed herein, regulatory limits may limit an amount of energy (e.g., EIRP 235) that is emitted at elevations above an elevation of the first network entity 105-a during transmissions from the first network entity 105-a, which may reduce potential interference that may be experienced by aircraft or satellites. Such limits may be defined as an EIRP mask that provide a maximum allowable radiated power of a transmitter at different angles away from a main beam of the transmitter. In cases of elevation transmissions, the EIRP mask may cap an amount of interference seen by satellites, aircraft, drones, or other aerial objects (e.g., potential victim nodes). As also discussed herein, in order to use frequency bands that are subject to EIRP mask definitions, a transmitting device (e.g., first network entity 105-a) may perform compliance tests to verify compliance with one or more EIRP masks. Further, in order to have a high degree of confidence that an EIRP mask definition is met, a relatively large number of samples may be needed, which may consume a relatively large amount of power and take a relatively long time. In some aspects, parameters for designing an EIRP mask may include a number of beamforming vectors (denoted as K) and the beam weights (wₖ) over which testing is performed, a sampling grid size (e.g., N sampling points in azimuth) over which EIRP is averaged and estimated, and a weight associated with each beamforming vector in the EIRP computation.

In some aspects, in order to provide for relatively low cost collection of EIRP measurements, a relatively small quantity of beamforming vectors (K) may be desired, such as 15, 16, 20, 25, etc. Such a quantity may have a relatively low cost for a network operator deploying the first network entity 105-a, but may result in a confidence level that actual EIRP values are within regulatory limits that may not be as high as desired by regulatory entities. In this context, a confidence interval (CI) is an interval which is expected to typically contain the parameter being estimated. More specifically, given a confidence level, v, (e.g., v=95% or 99%), a CI is a random interval which contains the parameter being estimated with a probability of v. For example, let X₁, . . . , X_{K} be independent measurements from a distribution with an unknown mean (denoted as μ). The 95th percentile CI is defined as the interval:

$$[ \overline{x} - \frac{cs}{\sqrt{K}} , \overline{x} + \frac{cs}{\sqrt{K}} ]$$

where x̅ and s denote the sample mean and sample standard deviation of the measurements, c is based on a probability distribution of the sample space (e.g., typically is 1.96 assuming Gaussian distribution for the Xᵢ's). As can be noted from the above, the CI range reduces as K increases, and thus a higher quantity of measurements provides a smaller CI range, and allowing a higher confidence that the metric of interest (e.g., average EIRP) does not exceed the upper limit of the CI with a high probability.

Accordingly, regulatory entities may desire a relatively large quantity or measurements, which in many cases will far exceed a quantity of measurements desired by the network operator for a relatively low cost compliance verification. The various bootstrap resampling techniques as discussed herein may provide for relatively high confidence with a sample space that is not too costly to obtain. In some aspects, the EIRP configuration information 225 may include, for example, a quantity of measurements of EIRP that are to be performed, a quantity of subsamples of the EIRP measurements that are to be used for resampling, a quantity of azimuth angles over which an average EIRP is to be obtained, an acceptable maximum value of a bootstrap confidence interval range, or any combination thereof. Techniques for performing the bootstrap resampling are discussed in more detail with reference to the example of FIG. 2.

In some aspects, the first network entity 105-a may transmit a set of reference signals to enable measurement EIRP 235, and may obtain the quantity of EIRP measurements. For example, EIRP measurements may be made at one or more measurement antennas that are located above the first network entity 105-a, or may be made by one or more drones or other measurement devices that are located at one or more elevations of interest (e.g., which may include a UE 115 that transmits measurement results to the first network entity). The first network entity 105-a may obtain the of EIRP measurements (e.g., a quantity of measurements indicated in the EIRP configuration information 225), and perform bootstrap resampling obtain a bootstrap confidence interval range 230 associated with the EIRP measurements. The bootstrap confidence interval range 230 may be provided to the second network entity 215 to verify conformance of the first network entity 105-a with one or more EIRP mask threshold values.

In some aspects, the EIRP measurements and bootstrap confidence interval determination may be performed prior to deployment of the first network entity 105-a in a wireless communications network. Additionally, or alternatively, the EIRP measurements and bootstrap confidence interval determination may be performed after to deployment of the first network entity 105-a in the wireless communications network. Further, in some aspects, communication of conformance may be dynamic or time-dependent as the first network entity 105-a changes beamforming behavior to traffic conditions.

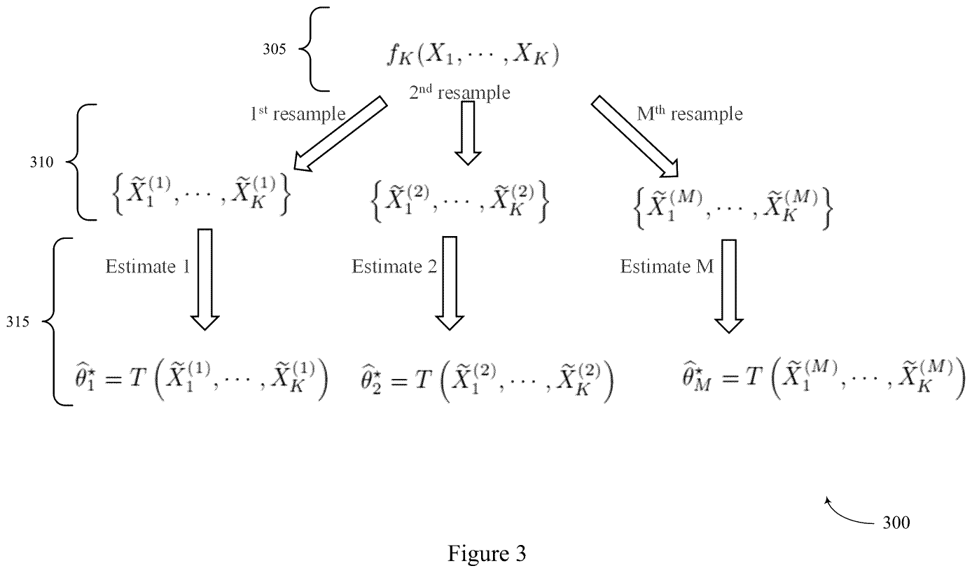

FIG. 3 shows an example of a resampling configuration 300 that supports techniques for EIRP mask compliance estimation via bootstrap resampling. In some examples, the resampling configuration 300 may be implemented by aspects of wireless communications system 100 or signaling configuration 200, as described with reference to FIGS. 1 and 2, or one or more network entities as discussed with reference to FIGS. 1 and 2.

As discussed, an EIRP mask may provide a maximum or average permissible EIRP level over a specific angle (e.g., typically elevation angle θ₀) and an aggressor device or node (e.g., a network entity that transmits wireless transmissions to a UE) is expected to transmit within the prescribed specifications, such that when transmission power is below the specifications, interference at victim nodes may be reduced or eliminated. The EIRP mask EIRP(θ₀) may be defined as:

$$EIRP ( {θ}_{0} ) = \frac{1}{KN} {\sum }_{k = 1}^{K} {\sum }_{n = 1}^{N} {𝓌}_{nk} \cdot P ( {θ}_{0} , {ϕ}_{n} , {w}_{k} )$$

where K is the number of beamforming vectors, N is the number of azimuth angles, wₙₖ is a weighting factor, P(.,.,.) is the observed power over θ₀ and φₙ with θ₀ denoting the elevation angle (e.g., zenith angle), φₙ denoting the sample azimuth angle, and wₖ denoting the sample beamforming vector. In accordance with this equation, an average is taken of the power over N azimuth angles (φₙ) with K beamforming vectors wₖ. In accordance with techniques as discussed herein, the confidence may be enhanced in cases where K (e.g., the number or samples) is relatively small through a bootstrap resampling procedure, which provides for randomly sampling a sample space with replacement to generate multiple sets of samples. A goal of bootstrap resampling is to estimate a sample statistic θ from X₁, . . . , X_{K} (e.g., mean, median, standard deviation). The bootstrap resampling procedure may use data from a sample study as a “surrogate population,” resample with replacement from the sample data at hand, create a relatively large number of “phantom samples” (e.g., bootstrap samples), compute a sample statistic from the bootstrap samples, and generate a bootstrap distribution of the sample statistic and thereby the bootstrap confidence interval.

Mathematically, instead of a direct computation of \hat{θ}=T(X₁, . . . , X_{K}), a sample space 305 includes K samples (e.g., K EIRP measurements). From within the sample space, a set of resamples 310 (e.g., M resamples) may be made that each include K′ samples of the K samples. From each of the resamples, a set of estimates 315 (e.g., M estimates, \hat{θ}*) may be generated. More generally,

$$P ( \hat{θ} \leq t ) \approx \frac{{\sum }_{i = 1}^{M} ϰ ( \{ {\hat{θ}}_{i}^{★} \leq t \} )}{M} .$$

It is assumed that the behavior of \hat{θ}−θ is approximately the same as the behavior of \hat{θ}*−\hat{θ}, in accordance with the bootstrap central limit theorem. Thus, given K samples, there are K^{K} possible sets of K-tuples that can be selected with replacement. Two sources of error may be present in such techniques, including an assumption that \tilde{X}₁⁽ⁱ⁾, . . . , \tilde{X}_{K}⁽ⁱ⁾ are bona fide samples from the true distribution f(.), and an assumption that averaging over M resamples [M=number of estimates from resampling] is sufficient to approximate the true bootstrap distribution from N^{N} resamples [N=number of actual measurements]. To reduce the first error, N may be selected to be reasonably large (e.g., N>100), and to reduce the second error, M may be selected to be reasonably large (e.g., M>300 for estimating variance, or more for other quantiles, and in general, M>1000 may be sufficient, or a quantity based on N may be used, such as M=N² or N log(N)).

In accordance with such techniques, if N EIRP samples could be used to generate a sufficiently high confidence through direct computations, N′ samples (where N′ is reasonably large but less than N) and M resamplings (where M is relatively large) may be used instead, which results in a trade-off between computational resources for sampling time and cost. Thus, in various aspects, a network entity may obtain K measurements of EIRP over K specified beamforming directions and average it over N azimuth angles to obtain average EIRP over a set of elevation angles. The network entity may subsample K′ measurements (out of K), perform M_{K′} resamplings of these measurements, and estimate a bootstrap confidence interval range from these measurements. In some cases, the network entity may communicate bootstrap confidence interval range versus K′ to a regulatory entity for conformance behavior. A s discussed herein, communication may be performed before field deployment of the network entity, or in an on-demand manner. Further, communication of conformance can be dynamic or time-dependent as the network entity changes beamforming behavior to traffic conditions. In some aspects, a regulatory entity may specify a set of K′ values and K values for which true measurements are made, may also specify M_{K′} values corresponding to each specified K′ value (for resampling), and may can specify an acceptable maximum value of a bootstrap confidence interval range. In some aspects such values may be provided to the network entity in configuration information. The network entity may communicate observed bootstrap confidence interval ranges for different K′ values to another network entity, such as a compliance entity that verifies conformance to EIRP regulations. Further, as the network entity meets regulations for some K′<K (actual number of measurements made), it adds more confidence to conformance of aggressor device to regulations.

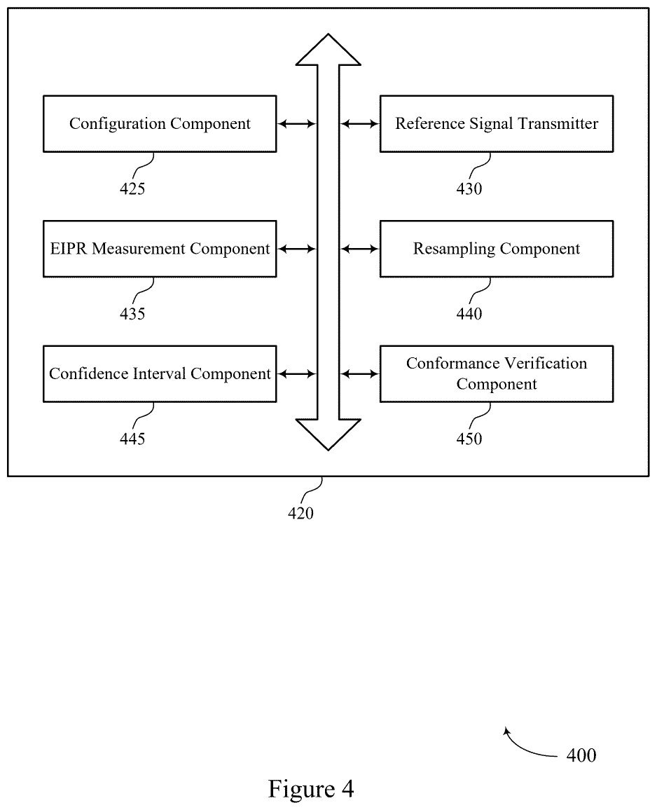

FIG. 4 shows an example 400 of a processing system 420 that supports techniques for EIRP mask compliance estimation via bootstrap resampling. A processing system 420 may be an example of a processing system 145 (such as network entity 105) and may include a configuration component 425, a reference signal transmitter 430, a EIPR measurement component 435, a resampling component 440, a confidence interval component 445, a conformance verification component 450, or any combination thereof. A processing system 420, or various component thereof, may be an example of means for performing (such as a means for causing a network entity 105 to perform) various techniques described herein.

The configuration component 425 may be configured to cause the network entity 105 to obtain configuration information for EIRP mask compliance estimation over a zenith angle for wireless transmissions of the network entity, the configuration information indicating a first quantity of EIRP measurements to be taken over a first quantity of beamforming directions and a first quantity of azimuth angles, and the configuration information further indicating a first quantity of samples of the first quantity of EIRP measurements to be used for bootstrap resampling of the first quantity of EIRP measurements to obtain a bootstrap confidence interval associated with the first quantity of EIRP measurements. The reference signal transmitter 430 may be configured to cause the network entity 105 to output a first quantity of signals for measurement of the EIRP, the first quantity of signals associated with to the first quantity of EIRP measurements. The EIPR measurement component 435 may be configured to cause the network entity 105 to obtain the first quantity of EIRP measurements of the first quantity of signals. The resampling component 440 may be configured to cause the network entity 105 to determine, based on a set of multiple average EIRP measurements from a set of multiple different subsets of the first quantity of EIRP measurements, the bootstrap confidence interval associated with the first quantity of EIRP measurements, where each of the set of multiple different subsets of the first quantity of EIRP measurements include a quantity of samples corresponding to the first quantity of samples. The confidence interval component 445 may be configured to cause the network entity 105 to output the bootstrap confidence interval to verify conformance of the network entity with one or more EIRP mask threshold values.

In some examples, the configuration information further includes a first quantity of resampling averages that indicates how many different subsets of the first quantity of EIRP measurements are included in the set of multiple different subsets of the first quantity of EIRP measurements. In some examples, the bootstrap confidence interval is determined prior to deployment of the network entity in a wireless communications network, or subsequent to deployment of the network entity in the wireless communications network. In some examples, the bootstrap confidence interval is determined in an on-demand manner subsequent to deployment of the network entity in the wireless communications network.

In some examples, the conformance of the network entity with one or more EIRP mask threshold values is communicated for multiple communication states of the network entity based on different beamforming behavior or traffic conditions of the network entity. In some examples, the first quantity of samples of the first quantity of EIRP measurements is defined in a regulatory specification for EIRP measurements. In some examples, multiple different values of the first quantity of samples are provided in the configuration information, and the network entity outputs bootstrap confidence intervals for each of the multiple different values of the first quantity of samples.

In some examples, the configuration component 425 may be configured to cause the network entity 105 to transmit, to a first network entity, configuration information for EIRP mask compliance estimation over a zenith angle for wireless transmissions of the first network entity, the configuration information indicating a first quantity of EIRP measurements to take over a first quantity of beamforming directions and a first quantity of azimuth angles, and the configuration information further indicating a first quantity of samples of the first quantity of EIRP measurements to be used for bootstrap resampling of the first quantity of EIRP measurements to obtain a bootstrap confidence interval range of the first quantity of EIRP measurements. In some examples, the confidence interval component 445 may be configured to cause the network entity 105 to receive, from the first network entity, the bootstrap confidence interval range for the first quantity of EIRP measurements of the first network entity. The conformance verification component 450 may be configured to cause the network entity 105 to verify conformance of the first network entity with one or more EIRP threshold values.

In some examples, the configuration information further includes a first quantity of resampling averages that indicates how many different subsets of the first quantity of EIRP measurements are included in a set of multiple different subsets of the first quantity of EIRP measurements that are used to determine the bootstrap confidence interval range from the first quantity of EIRP measurements.

In some examples, the bootstrap confidence interval is obtained prior to deployment of the first network entity in a wireless communications network, or subsequent to deployment of the first network entity in the wireless communications network. In some examples, the bootstrap confidence interval is obtained in an on-demand manner subsequent to deployment of the first network entity in the wireless communications network. In some examples, the conformance of the first network entity with one or more EIRP mask threshold values is determined for multiple communication states of the first network entity based on different beamforming behavior or traffic conditions of the first network entity.

In some examples, the first quantity of samples of the first quantity of EIRP measurements is defined in a regulatory specification for EIRP measurements. In some examples, multiple different values of the first quantity of samples are provided in the configuration information, and the first network entity outputs bootstrap confidence interval ranges for each of the multiple different values of the first quantity of samples.

A processing system 420 may include or be an example of one or more chips, SoCs, chipsets, packages, components, or devices that individually or collectively constitute or include a processing system. A processing system 420 may interface with other components of a network entity 105. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a network entity 105). Operations described herein with reference to the processing system 420, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 420 for operation in a processing system 420 as described herein, the processing system 420 may support techniques for bootstrap resampling obtain a bootstrap confidence interval associated with a quantity of EIRP measurements, which may be used to verify EIRP conformance using a relatively small quantity of measurements and associated transmissions from a network entity, and may reduce an amount of time associated with conformance testing while maintaining a relatively high confidence of conformance.

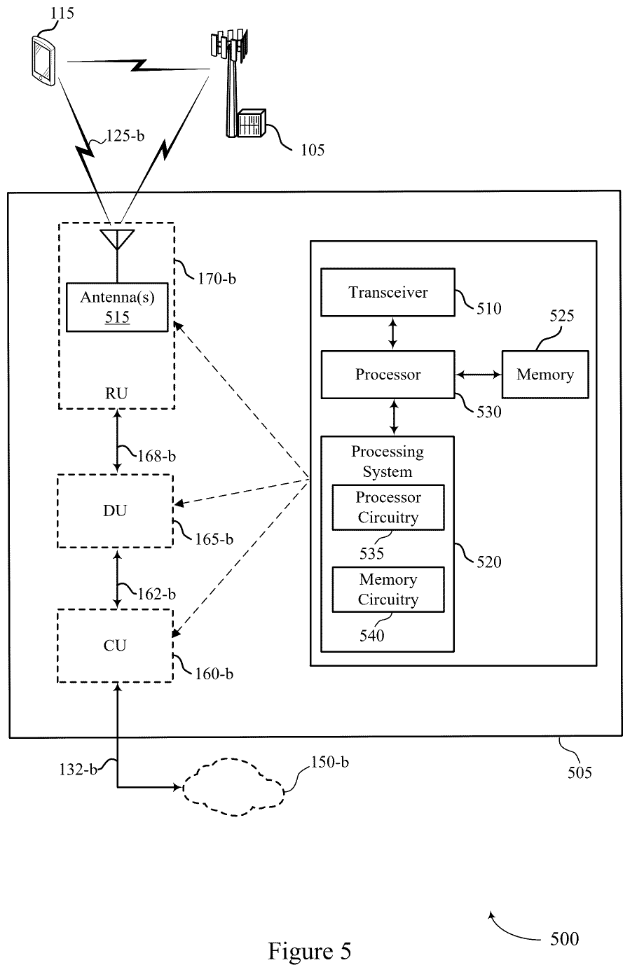

FIG. 5 shows an example of a system 500 including a device 505 that supports techniques for EIRP mask compliance estimation via bootstrap resampling. The device 505 may communicate (such as via one or more wired interfaces or one or more wireless interfaces) with other network devices or network equipment such as a core network 150-b, other network entities 105, UEs 115, or any combination thereof. The device 505 may include components for transmitting and receiving communication, which may include a processing system 520, a transceiver 510, antenna(s) 515, a memory 525, and a processor 530. Components of the device 505 may be coupled (such as operatively, communicatively, functionally, electronically, electrically, in electronic communication) via one or more interfaces.

The transceiver 510 may communicate bi-directionally with another transceiver via wired or wireless links, and may support transmission operations, reception operations, or both, as described herein. The transceiver 510 may include a modem to modulate and demodulate signals, to provide the modulated signals for transmission (such as via antenna(s) 515, via a wired interface), and to demodulate received signals (such as received via antenna(s) 515, received via a wired interface). The transceiver 510 may be operable to support communication via one or more communication links (such as a communication link 125-b, a backhaul link 132-b, a midhaul link 162-b, fronthaul link 168-b).

The processor 530 may be a general-purpose processing component that supports various operations (such as applications) of the device 505. The memory 525 may be a general-purpose storage component that stores code executable by the processor 530. Such code may include instructions that, when executed by the processor 530, cause the device 505 to perform various functions (such as to support an application of the device 505).

For examples in which the device 505 is a network entity 105 in a disaggregated architecture, one or more components of the device 505 may be located at one or more of a CU 160-b, a DU 165-b, or an RU 170-b, one or more of which may include aspects of the processing system 520, the processor 530, the memory 525, or the transceiver 510. Functions of the device 505 may be performed at different components or an operation may be divided between different components (such as different functions being supported by aspects of the CU 160-b, the DU 165-b, or the RU 170-b, the transceiver 510, the processor 530, the memory 525, the processing system 520, or any combination thereof). For example, the processing system 520 may be a component of one or more of the CU 160-b, the DU 165-b, or the RU 170-b. In some examples, interfaces between components of device 505 (such as CU 160-b, DU 165-b, RU 170-b) may support communication at a protocol layer or between protocol layers of a protocol stack.

In some examples, the processing system 520 may manage aspects of communication with the core network 150-b (such as via a backhaul link 132). For example, the processing system 520 may manage the transfer of data communication for UEs 115 with a gateway of the core network 150-b. In some examples, the processing system 520 may manage communication with one or more other network entities 105 and may include a controller or scheduler for controlling communication with UEs 115 (such as in cooperation with the one or more other network entities 105). In some examples, the processing system 520 may support an interface (such as X2 interface, Xn interface) to provide communication between network entities 105.

The processing system 520 may be an example of a processing system 145 or a processing system 420. For example, the processing system 520 may include processor circuitry 535 and memory circuitry 540 that stores code, and the processing system 520 may be configured to cause the device 505 to perform operations that support techniques for EIRP mask compliance estimation via bootstrap resampling. Although the processing system 520 is illustrated as a separate component, which may involve a separate chip, chipset, or other module, in some implementations, one or more functions described with reference to the processing system 520 may be supported by or performed by a transceiver 510, antenna(s) 515, a processor 530, memory 525, or any combination thereof, such that a processing system 520 may include one or more of a transceiver 510, antenna(s) 515, a processor 530, memory 525, or any combination thereof. Further, processor circuitry 535 and memory circuitry 540 each may be implemented at the device 505 in accordance with an aggregated architecture, or the processor circuitry 535 and the memory circuitry 540 may be implemented at one or more of a CU 160-b, a DU 165-b, or an RU 170-b in accordance with a disaggregated architecture.

By including or configuring the processing system 520 for operation in the device 505 as described herein, may support techniques for bootstrap resampling obtain a bootstrap confidence interval associated with a quantity of EIRP measurements, which may be used to verify EIRP conformance using a relatively small quantity of measurements and associated transmissions from a network entity, and may reduce an amount of time associated with conformance testing while maintaining a relatively high confidence of conformance.

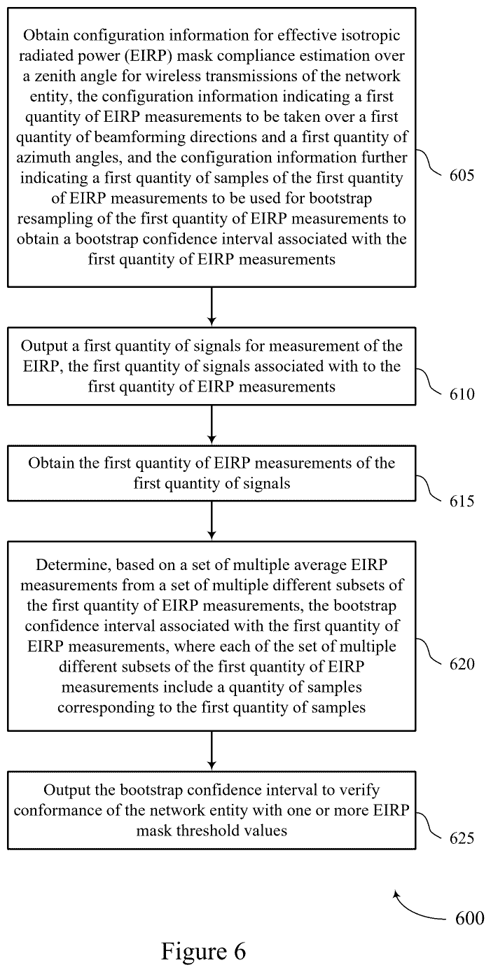

FIG. 6 shows an example of a method 600 that supports techniques for EIRP mask compliance estimation via bootstrap resampling. Operations of the method 600 may be performed by a network entity 105 or its components (such as using a processing system configured to cause the network entity to perform one or more operations) as described herein.

At 605, the method may include obtaining configuration information for EIRP mask compliance estimation over a zenith angle for wireless transmissions of the network entity, the configuration information indicating a first quantity of EIRP measurements to be taken over a first quantity of beamforming directions and a first quantity of azimuth angles, and the configuration information further indicating a first quantity of samples of the first quantity of EIRP measurements to be used for bootstrap resampling of the first quantity of EIRP measurements to obtain a bootstrap confidence interval associated with the first quantity of EIRP measurements. In some examples, aspects of the operations of 605 may be performed by a configuration component 425.

At 610, the method may include outputting a first quantity of signals for measurement of the EIRP, the first quantity of signals associated with to the first quantity of EIRP measurements. In some examples, aspects of the operations of 610 may be performed by a reference signal transmitter 430.

At 615, the method may include obtaining the first quantity of EIRP measurements of the first quantity of signals. In some examples, aspects of the operations of 615 may be performed by a EIPR measurement component 435.

At 620, the method may include determining, based on a set of multiple average EIRP measurements from a set of multiple different subsets of the first quantity of EIRP measurements, the bootstrap confidence interval associated with the first quantity of EIRP measurements, where each of the set of multiple different subsets of the first quantity of EIRP measurements include a quantity of samples corresponding to the first quantity of samples. In some examples, aspects of the operations of 620 may be performed by a resampling component 440.

At 625, the method may include outputting the bootstrap confidence interval to verify conformance of the network entity with one or more EIRP mask threshold values. In some examples, aspects of the operations of 625 may be performed by a confidence interval component 445.

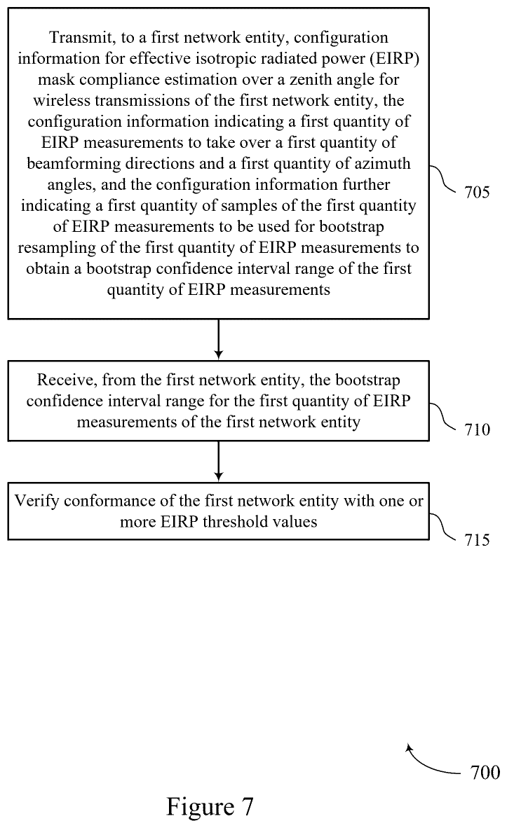

FIG. 7 shows an example of a method 700 that supports techniques for EIRP mask compliance estimation via bootstrap resampling. Operations of the method 700 may be performed by a network entity 105 or its components (such as using a processing system configured to cause the network entity to perform one or more operations) as described herein.

At 705, the method may include transmitting, to a first network entity, configuration information for EIRP mask compliance estimation over a zenith angle for wireless transmissions of the first network entity, the configuration information indicating a first quantity of EIRP measurements to take over a first quantity of beamforming directions and a first quantity of azimuth angles, and the configuration information further indicating a first quantity of samples of the first quantity of EIRP measurements to be used for bootstrap resampling of the first quantity of EIRP measurements to obtain a bootstrap confidence interval range of the first quantity of EIRP measurements. In some examples, aspects of the operations of 705 may be performed by a configuration component 425.

At 710, the method may include receiving, from the first network entity, the bootstrap confidence interval range for the first quantity of EIRP measurements of the first network entity. In some examples, aspects of the operations of 710 may be performed by a confidence interval component 445.

At 715, the method may include verifying conformance of the first network entity with one or more EIRP threshold values. In some examples, aspects of the operations of 715 may be performed by a conformance verification component 450.

Implementation examples are described in the following numbered clauses:

Aspect 1: A method for wireless communications at a network entity, comprising: obtaining configuration information for EIRP mask compliance estimation over a zenith angle for wireless transmissions of the network entity, the configuration information indicating a first quantity of EIRP measurements to be taken over a first quantity of beamforming directions and a first quantity of azimuth angles, and the configuration information further indicating a first quantity of samples of the first quantity of EIRP measurements to be used for bootstrap resampling of the first quantity of EIRP measurements to obtain a bootstrap confidence interval associated with the first quantity of EIRP measurements; outputting a first quantity of signals for measurement of the EIRP, the first quantity of signals associated with to the first quantity of EIRP measurements; obtaining the first quantity of EIRP measurements of the first quantity of signals; determining, based at least in part on a plurality of average EIRP measurements from a plurality of different subsets of the first quantity of EIRP measurements, the bootstrap confidence interval associated with the first quantity of EIRP measurements, wherein each of the plurality of different subsets of the first quantity of EIRP measurements include a quantity of samples corresponding to the first quantity of samples; and outputting the bootstrap confidence interval to verify conformance of the network entity with one or more EIRP mask threshold values.

Aspect 2: The method of aspect 1, wherein the configuration information further includes a first quantity of resampling averages that indicates how many different subsets of the first quantity of EIRP measurements are included in the plurality of different subsets of the first quantity of EIRP measurements.

Aspect 3: The method of any of aspects 1 through 2, wherein the bootstrap confidence interval is determined prior to deployment of the network entity in a wireless communications network, or subsequent to deployment of the network entity in the wireless communications network.

Aspect 4: The method of aspect 3, wherein the bootstrap confidence interval is determined in an on-demand manner subsequent to deployment of the network entity in the wireless communications network.

Aspect 5: The method of any of aspects 1 through 4, wherein the conformance of the network entity with one or more EIRP mask threshold values is communicated for multiple communication states of the network entity based at least in part on different beamforming behavior or traffic conditions of the network entity.

Aspect 6: The method of any of aspects 1 through 5, wherein the first quantity of samples of the first quantity of EIRP measurements is defined in a regulatory specification for EIRP measurements.

Aspect 7: The method of aspect 6, wherein multiple different values of the first quantity of samples are provided in the configuration information, and the network entity outputs bootstrap confidence intervals for each of the multiple different values of the first quantity of samples.

Aspect 8: A method for wireless communications at a second network entity conforming to EIRP regulations, comprising: transmitting, to a first network entity, configuration information for EIRP mask compliance estimation over a zenith angle for wireless transmissions of the first network entity, the configuration information indicating a first quantity of EIRP measurements to take over a first quantity of beamforming directions and a first quantity of azimuth angles, and the configuration information further indicating a first quantity of samples of the first quantity of EIRP measurements to be used for bootstrap resampling of the first quantity of EIRP measurements to obtain a bootstrap confidence interval range of the first quantity of EIRP measurements; receiving, from the first network entity, the bootstrap confidence interval range for the first quantity of EIRP measurements of the first network entity; and verifying conformance of the first network entity with one or more EIRP threshold values.

Aspect 9: The method of aspect 8, wherein the configuration information further includes a first quantity of resampling averages that indicates how many different subsets of the first quantity of EIRP measurements are included in a plurality of different subsets of the first quantity of EIRP measurements that are used to determine the bootstrap confidence interval range from the first quantity of EIRP measurements.

Aspect 10: The method of any of aspects 8 through 9, wherein the bootstrap confidence interval is obtained prior to deployment of the first network entity in a wireless communications network, or subsequent to deployment of the first network entity in the wireless communications network.

Aspect 11: The method of aspect 10, wherein the bootstrap confidence interval is obtained in an on-demand manner subsequent to deployment of the first network entity in the wireless communications network.

Aspect 12: The method of any of aspects 8 through 11, wherein the conformance of the first network entity with one or more EIRP mask threshold values is determined for multiple communication states of the first network entity based at least in part on different beamforming behavior or traffic conditions of the first network entity.

Aspect 13: The method of any of aspects 8 through 12, wherein the first quantity of samples of the first quantity of EIRP measurements is defined in a regulatory specification for EIRP measurements.

Aspect 14: The method of aspect 13, wherein multiple different values of the first quantity of samples are provided in the configuration information, and the first network entity outputs bootstrap confidence interval ranges for each of the multiple different values of the first quantity of samples.

Aspect 15: A network entity for wireless communications, comprising a processing system that includes processor circuitry and memory circuitry that stores code, the processing system configured to cause the network entity to perform a method of any of aspects 1 through 7.

Aspect 16: A network entity for wireless communications, comprising at least one means for performing a method of any of aspects 1 through 7.

Aspect 17: A non-transitory computer-readable medium storing code for wireless communications, the code comprising instructions executable by one or more processors to perform a method of any of aspects 1 through 7.

Aspect 18: A second network entity conforming to EIRP regulations for wireless communications, comprising a processing system that includes processor circuitry and memory circuitry that stores code, the processing system configured to cause the second network entity conforming to EIRP regulations to perform a method of any of aspects 8 through 14.

Aspect 19: A second network entity conforming to EIRP regulations for wireless communications, comprising at least one means for performing a method of any of aspects 8 through 14.

Aspect 20: A non-transitory computer-readable medium storing code for wireless communications, the code comprising instructions executable by one or more processors to perform a method of any of aspects 8 through 14.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
a processing system that includes processor circuitry and memory circuitry that stores code, the processing system configured to cause the network entity to:
obtain configuration information for effective isotropic radiated power (EIRP) mask compliance estimation over a zenith angle for wireless transmissions of the network entity, the configuration information indicating a first quantity of EIRP measurements to be taken over a first quantity of beamforming directions and a first quantity of azimuth angles, and the configuration information further indicating a first quantity of samples of the first quantity of EIRP measurements to be used for bootstrap resampling of the first quantity of EIRP measurements to obtain a bootstrap confidence interval associated with the first quantity of EIRP measurements;
output a first quantity of signals for measurement of the EIRP, the first quantity of signals associated with to the first quantity of EIRP measurements;
obtain the first quantity of EIRP measurements of the first quantity of signals;
determine, based at least in part on a plurality of average EIRP measurements from a plurality of different subsets of the first quantity of EIRP measurements, the bootstrap confidence interval associated with the first quantity of EIRP measurements, wherein each of the plurality of different subsets of the first quantity of EIRP measurements include a quantity of samples corresponding to the first quantity of samples; and
output the bootstrap confidence interval to verify conformance of the network entity with one or more EIRP mask threshold values.

2. The network entity of claim 1, wherein the configuration information further includes a first quantity of resampling averages that indicates how many different subsets of the first quantity of EIRP measurements are included in the plurality of different subsets of the first quantity of EIRP measurements.

3. The network entity of claim 1, wherein the bootstrap confidence interval is determined prior to deployment of the network entity in a wireless communications network, or subsequent to deployment of the network entity in the wireless communications network.

4. The network entity of claim 3, wherein the bootstrap confidence interval is determined in an on-demand manner subsequent to deployment of the network entity in the wireless communications network.

5. The network entity of claim 1, wherein the conformance of the network entity with one or more EIRP mask threshold values is communicated for multiple communication states of the network entity based at least in part on different beamforming behavior or traffic conditions of the network entity.

6. The network entity of claim 1, wherein the first quantity of samples of the first quantity of EIRP measurements is defined in a regulatory specification for EIRP measurements.

7. The network entity of claim 6, wherein multiple different values of the first quantity of samples are provided in the configuration information, and the network entity outputs bootstrap confidence intervals for each of the multiple different values of the first quantity of samples.

8. A second network entity conforming to effective isotropic radiated power (EIRP) regulations, comprising:
a processing system that includes processor circuitry and memory circuitry that stores code, the processing system configured to cause the second network entity conforming to effective isotropic radiated power (EIRP) regulations to:
transmit, to a first network entity, configuration information for effective isotropic radiated power (EIRP) mask compliance estimation over a zenith angle for wireless transmissions of the first network entity, the configuration information indicating a first quantity of EIRP measurements to take over a first quantity of beamforming directions and a first quantity of azimuth angles, and the configuration information further indicating a first quantity of samples of the first quantity of EIRP measurements to be used for bootstrap resampling of the first quantity of EIRP measurements to obtain a bootstrap confidence interval range of the first quantity of EIRP measurements;
receive, from the first network entity, the bootstrap confidence interval range for the first quantity of EIRP measurements of the first network entity; and
verify conformance of the first network entity with one or more EIRP threshold values.

9. The second network entity conforming to effective isotropic radiated power (EIRP) regulations of claim 8, wherein the configuration information further includes a first quantity of resampling averages that indicates how many different subsets of the first quantity of EIRP measurements are included in a plurality of different subsets of the first quantity of EIRP measurements that are used to determine the bootstrap confidence interval range from the first quantity of EIRP measurements.

10. The second network entity conforming to effective isotropic radiated power (EIRP) regulations of claim 8, wherein the bootstrap confidence interval range is obtained prior to deployment of the first network entity in a wireless communications network, or subsequent to deployment of the first network entity in the wireless communications network.

11. The second network entity conforming to effective isotropic radiated power (EIRP) regulations of claim 10, wherein the bootstrap confidence interval range is obtained in an on-demand manner subsequent to deployment of the first network entity in the wireless communications network.

12. The second network entity conforming to effective isotropic radiated power (EIRP) regulations of claim 8, wherein the conformance of the first network entity with one or more EIRP mask threshold values is determined for multiple communication states of the first network entity based at least in part on different beamforming behavior or traffic conditions of the first network entity.

13. The second network entity conforming to effective isotropic radiated power (EIRP) regulations of claim 8, wherein the first quantity of samples of the first quantity of EIRP measurements is defined in a regulatory specification for EIRP measurements.

14. The second network entity conforming to effective isotropic radiated power (EIRP) regulations of claim 13, wherein multiple different values of the first quantity of samples are provided in the configuration information, and the first network entity outputs bootstrap confidence interval ranges for each of the multiple different values of the first quantity of samples.

15. A method for wireless communications at a network entity, comprising:
obtaining configuration information for effective isotropic radiated power (EIRP) mask compliance estimation over a zenith angle for wireless transmissions of the network entity, the configuration information indicating a first quantity of EIRP measurements to be taken over a first quantity of beamforming directions and a first quantity of azimuth angles, and the configuration information further indicating a first quantity of samples of the first quantity of EIRP measurements to be used for bootstrap resampling of the first quantity of EIRP measurements to obtain a bootstrap confidence interval associated with the first quantity of EIRP measurements;
outputting a first quantity of signals for measurement of the EIRP, the first quantity of signals associated with to the first quantity of EIRP measurements;
obtaining the first quantity of EIRP measurements of the first quantity of signals;
determining, based at least in part on a plurality of average EIRP measurements from a plurality of different subsets of the first quantity of EIRP measurements, the bootstrap confidence interval associated with the first quantity of EIRP measurements, wherein each of the plurality of different subsets of the first quantity of EIRP measurements include a quantity of samples corresponding to the first quantity of samples; and
outputting the bootstrap confidence interval to verify conformance of the network entity with one or more EIRP mask threshold values.

16. The method of claim 15, wherein the configuration information further includes a first quantity of resampling averages that indicates how many different subsets of the first quantity of EIRP measurements are included in the plurality of different subsets of the first quantity of EIRP measurements.

17. The method of claim 15, wherein the bootstrap confidence interval is determined prior to deployment of the network entity in a wireless communications network, or subsequent to deployment of the network entity in the wireless communications network.

18. The method of claim 17, wherein the bootstrap confidence interval is determined in an on-demand manner subsequent to deployment of the network entity in the wireless communications network.

19. The method of claim 15, wherein the conformance of the network entity with one or more EIRP mask threshold values is communicated for multiple communication states of the network entity based at least in part on different beamforming behavior or traffic conditions of the network entity.

20. The method of claim 15, wherein the first quantity of samples of the first quantity of EIRP measurements is defined in a regulatory specification for EIRP measurements.
